(19) United States
(12) Patent Application Publication
(10) Pub. No.: US 2023/0195507 A1
(43) Pub. Date: Jun. 22, 2023

(54) LOCAL TO REMOTE APPLICATION SWITCHING

(71) Applicant: Citrix Systems, Inc., Fort Lauderdale, FL (US)

(72) Inventors: Zongpeng Qiao, Nanjing (CN); Ke Xu, Nanjing (CN); Xiao Zhang, Nanjing (CN); Jie Zhuang, Nanjing (CN)

(21) Appl. No.: 17/646,313

(22) Filed: Dec. 29, 2021

Related U.S. Application Data
(63) Continuation of application No. PCT/CN2021/140288, filed on Dec. 22, 2021.

(51) Int. Cl. G06F 9/48; G06F 9/445

(52) U.S. Cl. CPC G06F 9/48; G06F 9/44594; G06F 3/0482

(57) ABSTRACT

A system and method for switching from a locally executing application to a remotely executing application. A method includes: detecting a launch of an application on a computing device, the application being executable locally on the computing device; rendering an element in a user interface presented within a display of the computing device, the element configured to substitute the application with a corresponding application that executes on a remote computing device; and in response to input received on the element, launching the corresponding application on the remote computing device and terminating execution of the application on the computing device.

### BACKGROUND OF THE DISCLOSURE

Remote application delivery solutions, such as software as a service (SaaS), virtualized workspaces, etc., provide numerous benefits for enterprises. For instance, such solutions allow for uniform management of information technology (IT) resources, e.g., ensuring all users within an enterprise utilize the same version of an application. Rather than executing applications on a client device (e.g., smartphones, laptops, desktops, etc.), these solutions use a server infrastructure, such as a cloud, to remotely execute applications that a user can access from the client device. For example, virtual workspace environments utilize virtual desktops and applications that execute on a remote workspace platform but display on a local client computing device.

### BRIEF DESCRIPTION OF THE DISCLOSURE

Aspects of this disclosure provide systems and methods that provide users of client computing devices with a seamless solution to switch from locally executing applications to corresponding remotely executing applications.

A first aspect of the disclosure provides a computing device having a display, a memory storing instructions, and a processor coupled to the memory and the display. The processor is configured to execute the instructions to perform processes including detecting a launch of an application on the computing device, the application being executable locally on the computing device; and rendering an element in a user interface presented within the display, the element configured to substitute the application with a corresponding application that executes on a remote computing device. In response to input received on the element, launching the corresponding application on the remote computing device such that the corresponding application is accessible on the computing device. Execution of the application on the computing device is then terminated.

A second aspect of the disclosure provides a method for switching to remote applications on a computing device. The method includes detecting a launch of an application on the computing device in which the application is locally executing and rendering an element in a user interface presented within a display of the computing device, the element configured to substitute the application with a corresponding application that executes on a remote computing device. In response to input received on the element, launching the corresponding application on the remote computing device and terminating execution of the application on the computing device.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts an illustrative computing environment configured to implement switching between a locally running application and a corresponding remotely running application, in accordance with an illustrative embodiment.

FIG. 2 depicts a locally running application with an interactive element, in accordance with an illustrative embodiment.

FIG. 3 depicts the locally running application of FIG. 2 with the interactive element and a pop-up dialog, in accordance with an illustrative embodiment.

FIG. 4 depicts the locally running application of FIG. 2 with the interactive element and an alternative pop-up dialog, in accordance with an illustrative embodiment.

FIG. 5 depicts window schematics for locating the interactive element, in accordance with an illustrative embodiment.

FIG. 6 depicts a sequence diagram, in accordance with an illustrative embodiment.

FIG. 7 depicts a network infrastructure, in accordance with an illustrative embodiment.

FIG. 8 depicts a computing system, in accordance with an illustrative embodiment.

FIG. 9A is a block diagram of an example system in which resource management services may manage and streamline access by clients to resource feeds (via one or more gateway services) and/or software-as-a-service (SaaS) applications.

FIG. 9B is a block diagram showing an example implementation of the system shown in FIG. 9A in which various resource management services as well as a gateway service are located within a cloud computing environment.

FIG. 9C is a block diagram similar to that shown in FIG. 9B in which the available resources are represented by a single box labeled “systems of record,” and further in which several different services are included among the resource management services.

The drawings are intended to depict only typical aspects of the disclosure, and therefore should not be considered as limiting the scope of the disclosure.

### DETAILED DESCRIPTION OF THE DISCLOSURE

Technical solutions are described herein that involve interactions between a local computing device and a remote computing device. More particularly, approaches are provided that allow an application executing on the local computing device (i.e., client device) to be substituted with a corresponding application that executes on the remote computing device (e.g., a server infrastructure) but displays on the client device. In various aspects, the term “corresponding application” refers to an application configured to run on a remote computing device that is essentially the same as an application configured to run on a client device, i.e., both will typically have the same name and perform substantially the same functions. For example, an application such as MS OUTLOOK® is available as a locally executing application, e.g., on a WINDOWS® operating system computer, and as a corresponding remotely executing application, e.g., as a web-based application, a software as a service (SaaS) application, or a virtualized application running on a remote server.

In some embodiments, substitution between a locally executing application and a remote corresponding application is accomplished by rendering an interactive element, e.g., a graphical user interface (GUI) feature, on a display of the client device in response to detecting the launch of a local application on the client device. Interaction with the element, e.g., clicking a button, allows a user to seamlessly substitute the local application with a corresponding application that runs on the remote computing system. The described solutions can be implemented in any remote application delivery architecture that allows applications to be run remotely from, and be presented on, a client device. In certain embodiments, the client device includes a virtualized desktop infrastructure (VDI) in which a workspace on a client device interacts with a workspace platform on a remote server infrastructure. Illustrative VDI environments include CITRIX® Workspace, available from Citrix System, Inc. of Fort Lauderdale, Fla., which provides an information retrieval service where users can access programs and files from a variety of sources through a central application or a Web browser.

While remote application delivery has numerous benefits for enterprise, typical client computing devices allow applications to be installed and run locally on the client computing device. Accordingly, different instances of the same application may be available to a user of a client device either as a standalone application configured to run locally on the client device and as a corresponding application that runs on a remote server session. From an enterprise standpoint, preference is typically for users to utilize remote applications versus local applications in order to provide centralized management, version control, etc. However, users may not be aware that a corresponding remote application exists or not want to bothered switching. The solutions described herein allow the user to seamlessly switch from a locally running application to a corresponding remote application by simply clicking (or otherwise interacting) with an interactive element displayed when the user launches the local application.

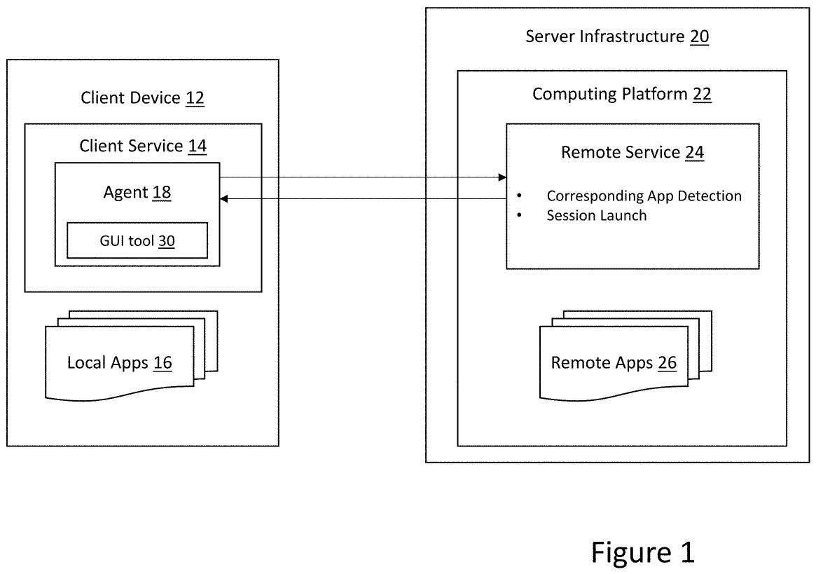

FIG. 1 depicts an illustrative computing environment that includes a client device 12 running a client service 14 and a computing platform 22 that runs within a server infrastructure 20. As shown, client device 12 includes a set of installed applications configured to execute locally, i.e., local Apps 16, and platform 22 includes a set of applications configured to execute remotely, i.e., remote Apps 26. In this embodiment, client service 14 includes an agent 18 (e.g., a recommendation agent) that interacts with a remote service 24 (e.g., a recommendation service) within the computing platform 22 to effectuate a seamless switch between a local App 16 and a corresponding remote App 26. To effectuate the solution, agent 18 is configured to detect the launch of a local App 16 (e.g., using a Windows system call such as Windows Startup Event Handler), and when detected, send associated application information to the recommendation service 24 to determine whether a corresponding remote App 26 exists (e.g., by comparing the name of the local App 16 with a set of available remote App names).

When a corresponding remote App 26 is detected, an indication that a match exists will be sent back to agent 14, which will then render an interactive element within the display of client device 12 with GUI tool 30. Interaction by a user of the client device 12 with the interactive element (e.g., clicking a button) in turn causes a session to be launched in the platform 22 that runs the corresponding remote App 26 for virtualization on the client 14. Once the corresponding remote App 26 is running, the original local App 16 is terminated on the client device 12 by the agent 18.

In various approaches, the remote App 26 can be instantiated at the client 12 using a virtualized desktop infrastructure (VDI) or the like, as well as any other remote application delivery technologies, such as a web-based or SaaS sessions using HTTP. Using HTTP sessions, the remote App 16 is accessed directly via a web browser pointed to a designated web address. In these various approaches, the remote service 24 creates a unique session for the user, which provides a temporary information exchange between the client device 12 and remote computing platform 22 for accessing the remote App 26 on the client device 12.

Determining whether a corresponding, i.e., “matching,” remote App 26 exists within the computing platform 22 can implemented by service 24 in any manner. Typically, matching applications will have similar names, and be highly coincident. Accordingly, in one example, the client service 14 sends the name of the local App 16 to the remote service 24, which then determines if any of the resource names of the remote Apps 26 contain the whole or some significant portion of the name string of the local App 16, e.g., using a function such as resource_name.contains(localapp _name). In more complex scenarios, other features can be compared, such as executable names, manufacturer name, signing keys of the applications to ensure they are the same applications, etc.

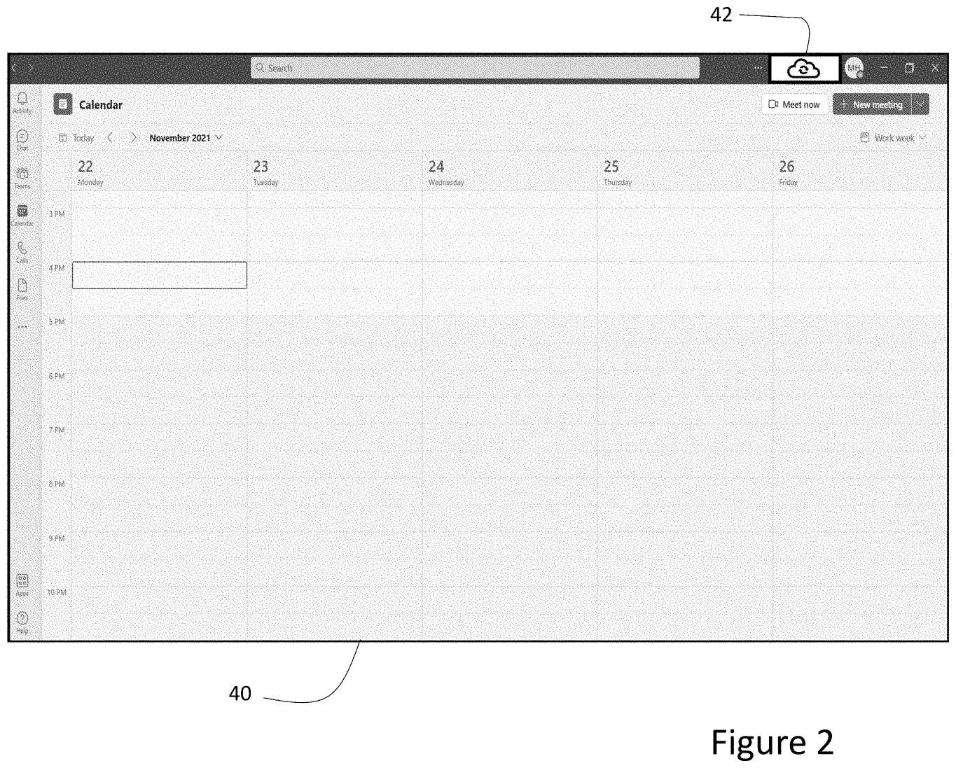

FIGS. 2-4 depict (with reference to FIG. 1) illustrative embodiments of an interactive element being rendered within a display of client device 12. FIG. 2 depicts an illustrative local App 40 (in this example, MICROSOFT TEAMS®) being executed and displayed on client device 12. When App 40's launch is detected by agent 18, application information (e.g., the App name, version, etc.) is forwarded to the remote service 24 to determine if a corresponding remote App 26 exists, e.g., by comparing the name of the remote App 40 with the names of remote Apps 26 available on computing platform 26. If one does exist, interactive element 42 is rendered in the local App 40, in this case on the toolbar, which allows the user to switch to the corresponding remote App. In some embodiments, in order to catch the attention of the user and recommend switching, the interactive element 42 may utilize visual, tactile, or auditory cues, e.g., highlights, colors, blinking, beeps, etc. Furthermore, although presented within a window of the local App 40, it is understood that element 42 could be rendered anywhere within the display of the client device, e.g., a separate window, a notification balloon, etc.

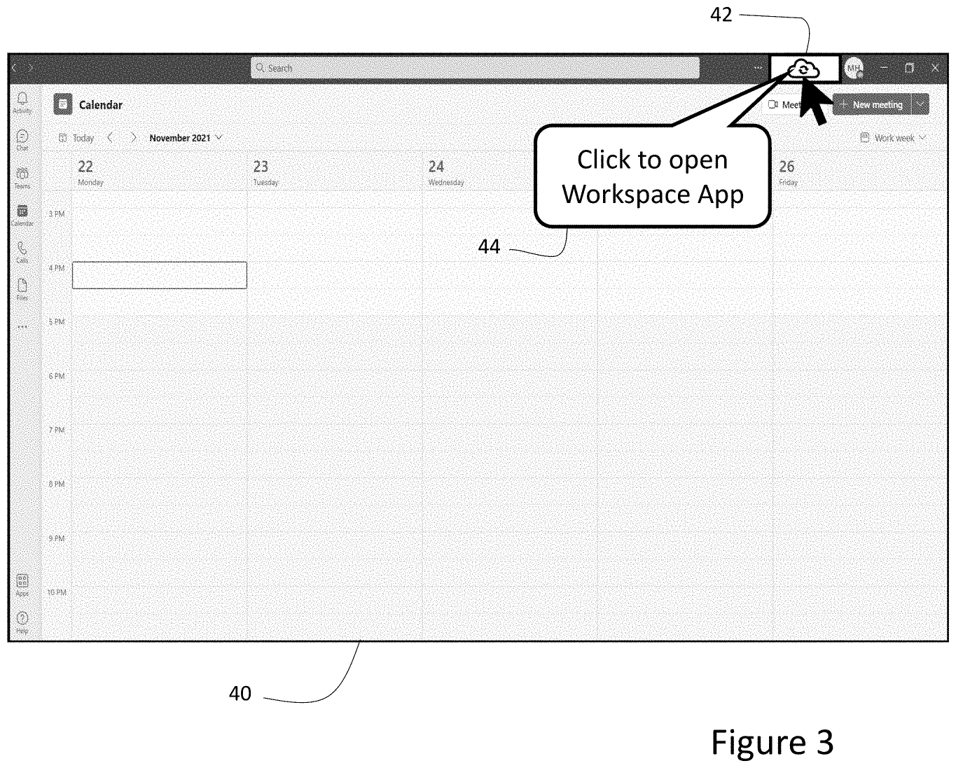

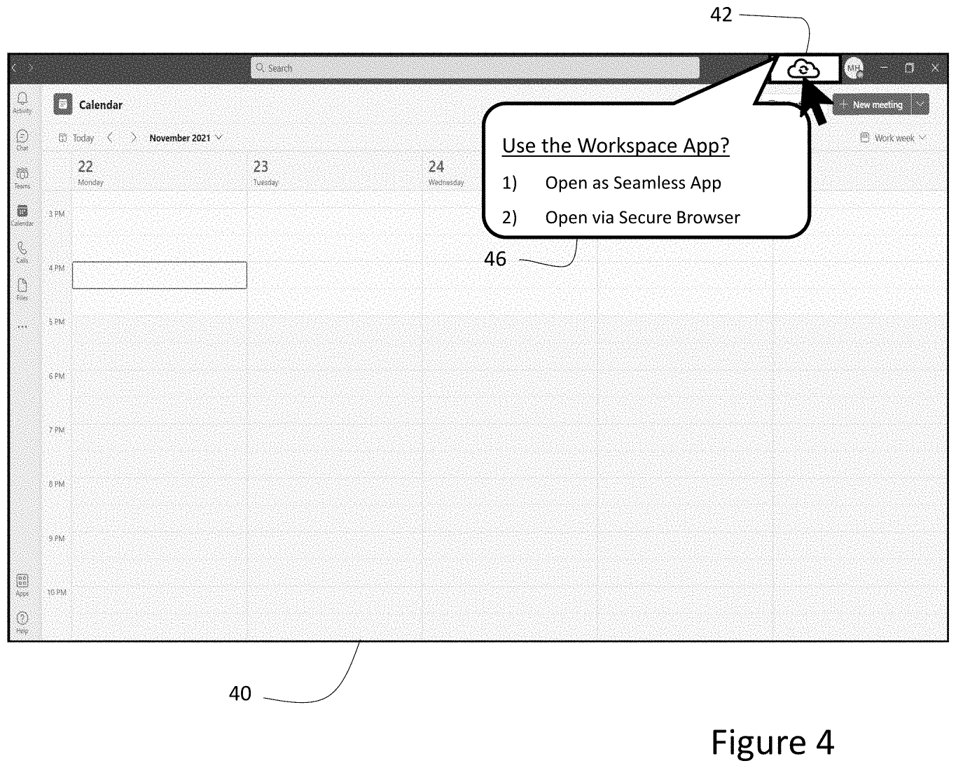

As shown in FIG. 3, when the user hovers their mouse pointer over the interactive element 42, a pop-up dialog 44 is displayed by the GUI tool 30 to recommend the corresponding remote App to the user. In this example, when the user clicks element 42, local App 40 is replaced by the corresponding remote App, i.e., a remotely executing MICROSOFT TEAMS application. It is understood that the remote App may be launched as a new session on the remote computing platform 22 or be opened using other techniques, such as a session of a secure or otherwise containerized browser. FIG. 4 depicts a variation in which hovering the mouse pointer over element 42 opens a pop-up dialog 46 with multiple options for switching to the remote App. In this example, the user is given the option to open the remote App as a seamless App (i.e., using a secure browser service) or open the remote App as a SaaS application in a secure browser. A secure browser service is for example deployed using an existing virtualization session, such as a Citrix ICA session. A Secure Browser may for example be deployed as part of a workspace platform in which a SaaS application is opened directly without the use of a session.

Interactive element 42 can be implemented and output by GUI tool 30 (FIG. 1) in any manner. Depending on the platform, rendering can be done using available system application programming interfaces (APIs), e.g., X Windows System in Linux, Graphics API in MS WINDOWS®, etc. Furthermore, the element 42 can be rendered using any type of graphical design or media format, e.g., a rectangular or round button, an icon, a dropdown option, a sound, a tactile output, a video clip, etc. Furthermore, interactive element 42 can be configured with additional functionality, such as a right-click option to hide the element until the next time the App 40 is launched, an option to locate the button elsewhere in the display, etc. In one illustrative embodiment, the GUI tool 30 interacts with the system API and renders the interactive element 42 as an additional graphic layer that is overlayed onto the display.

In some instances, location of element 42 is based on the window coordinates of the local App 40. In one approach, GUI tool 30 determines a size and location of the interactive element 42 as follows. To size the element, the interactive element 42 is implemented as a type “circle” whose diameter can be determined based on an existing structure used in the window that displays the App 40, e.g., the height of the menu bar or a maximize/minimize/close button. The following system API call can be made to obtain rectangle data for an existing structure:

```
public struct RECT
  {
  public int left;
  public int top;
  public int right;
  public int bottom;
  }
```

Accordingly, the diameter for the desired circle type can be calculated as:

diameter=(top−bottom).

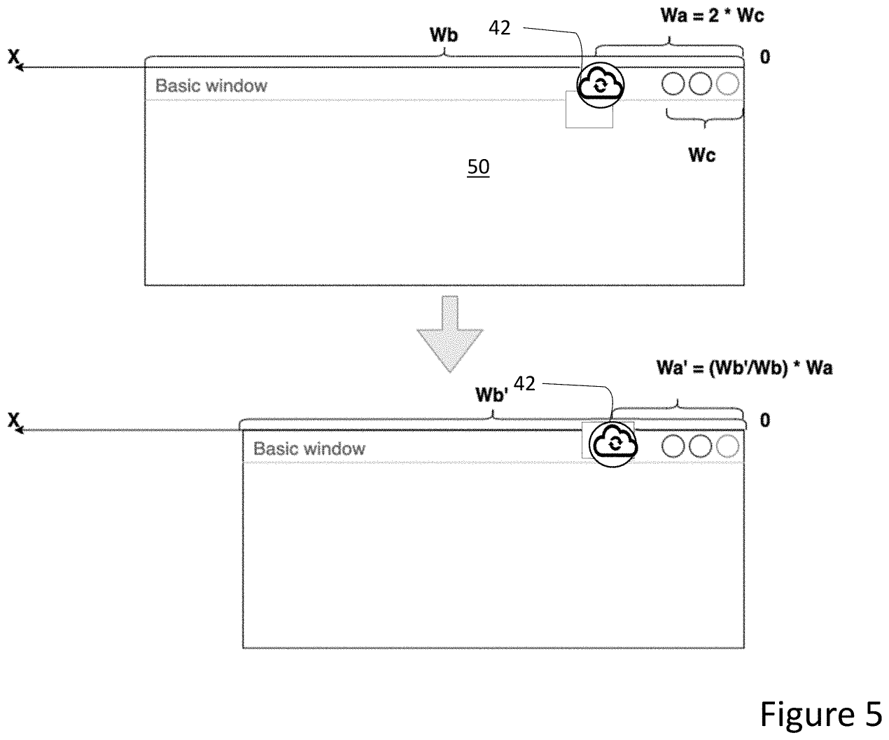

To determine the placement of the element 42 on the display, the location of the right-top border of the local App 40 is first determined via a further system API call, which can then be used to set up the coordinated system of the specific window in which the application is running. As shown in top image of FIG. 5, in any basic window 50, the width of the basic window 50 is Wb, the distance between minimize button and the right border of the window 50 is Wc, and the desired distance between interactive element 42 and the right border of the window 50 is Wa=2*Wc. The proportion of Wc and Wa can be used to calculate the distance between the element 42 and the right border of any new window. For example, as shown in the bottom image of FIG. 5, if the width of a new window 52 is Wb′, the element 42 position can be calculated as:

Wa′=(Wb′/Wb)*Wa.

This approach can be used in any application window to locate the interactive element 42. In certain embodiments, the calculated location can be identified as the initial default position for a specific local App. The user can thereafter move element 42 as need, and the new position for the specific application will be recorded locally by GUI tool 30. The new position will accordingly be used the next time the user opens the local App. Accordingly, even if the calculated position is not correct (e.g., it blocks an existing function button in window), the location of element 42 will not impact the App, because the user can always move (e.g., drag and drop) the element 42.

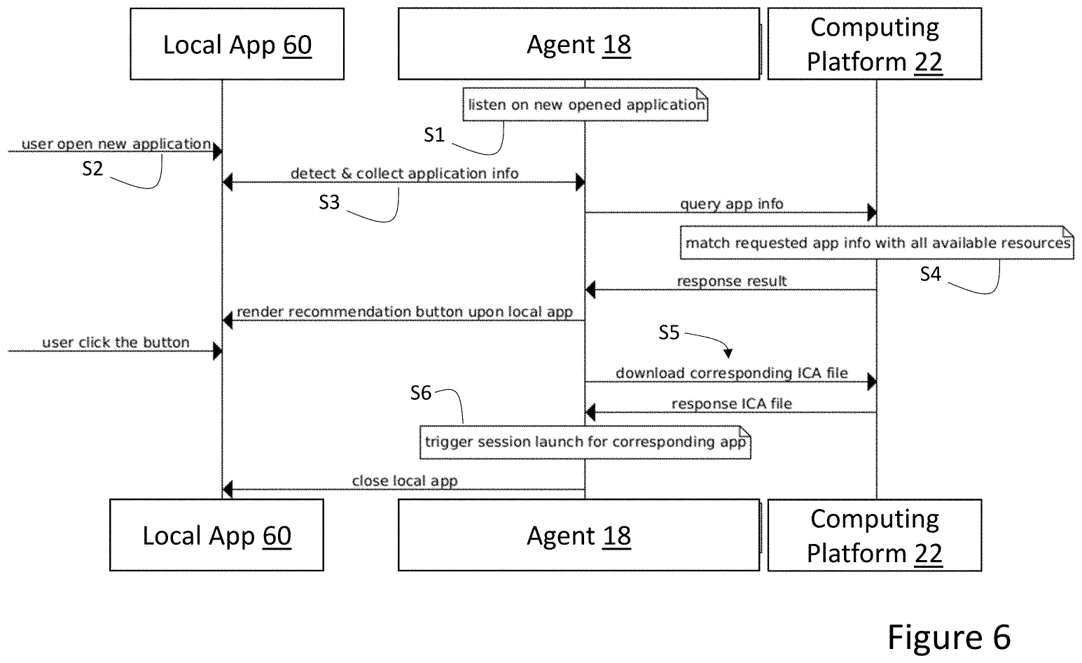

FIG. 6 depicts an overall flow for implementing an illustrative process. As shown, agent 18 runs in the background and listens for a new local App to be opened or otherwise launched at S1. When the user opens, i.e., launches, a local App 60 at S2, the agent 18 detects the launch and collects application information at S3. Agent 18 then forwards information about the application to the computing platform 22 with a query for a corresponding, i.e., matching, remote App. The computing platform receives the query and determines if there is a match with available resources (i.e., remote Apps) at S4. If a match exists, a response result of the query is returned to the agent 18, which renders an interactive element, e.g., a recommendation button, upon the local App 60 (e.g., using a graphical overlay). If the user clicks the button, the agent 18 will download a corresponding application configuration file, such as a CITRIX Independent Computing Architecture (ICA) file, from the computing platform 22 at S5. The application configuration file contains the configuration information for connecting the client service 14 to and launching the matching remote App. Once received, agent 18 will run the configuration file to trigger a session launch for the corresponding remote App at S6 and then close, i.e., terminate, the local App 60.

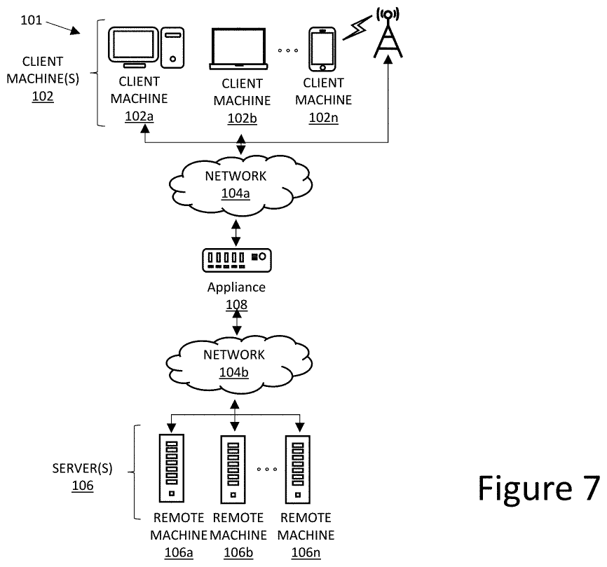

Referring to FIG. 7, a non-limiting network environment 101 in which various aspects of the disclosure may be implemented includes one or more client machines 102A-102N, one or more remote machines 106A-106N, one or more networks 104, 104′, and one or more appliances 108 installed within the computing environment 101. The client machines 102A-102N communicate with the remote machines 106A-106N via the networks 104, 104′.

In some embodiments, the client machines 102A-102N communicate with the remote machines 106A-106N via an intermediary appliance 108. The illustrated appliance 108 is positioned between the networks 104, 104′ and may also be referred to as a network interface or gateway. In some embodiments, the appliance 108 may operate as an application delivery controller (ADC) to provide clients with access to business applications and other data deployed in a datacenter, the cloud, or delivered as Software as a Service (SaaS) across a range of client devices, and/or provide other functionality such as load balancing, etc. In some embodiments, multiple appliances 108 may be used, and the appliance(s) 108 may be deployed as part of the network 104 and/or 104′.

The client machines 102A-102N may be generally referred to as client machines 102, local machines 102, clients 102, client nodes 102, client computers 102, client devices 102, computing devices 102, endpoints 102, or endpoint nodes 102. The remote machines 106A-106N may be generally referred to as servers 106 or a server farm 106. In some embodiments, a client device 102 may have the capacity to function as both a client node seeking access to resources provided by a server 106 and as a server 106 providing access to hosted resources for other client devices 102A-102N. The networks 104, 104′ may be generally referred to as a network 104. The networks 104 may be configured in any combination of wired and wireless networks.

A server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 106 may execute a remote presentation services program or other program that uses a thin-client or a remote-display protocol to capture display output generated by an application executing on a server 106 and transmit the application display output to a client device 102.

In yet other embodiments, a server 106 may execute a virtual machine providing, to a user of a client device 102, access to a computing environment. The client device 102 may be a virtual machine. The virtual machine may be managed by, for example, a hypervisor, a virtual machine manager (VMM), or any other hardware virtualization technique within the server 106.

In some embodiments, the network 104 may be: a local-area network (LAN); a metropolitan area network (MAN); a wide area network (WAN); a primary public network 104; and a primary private network 104. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

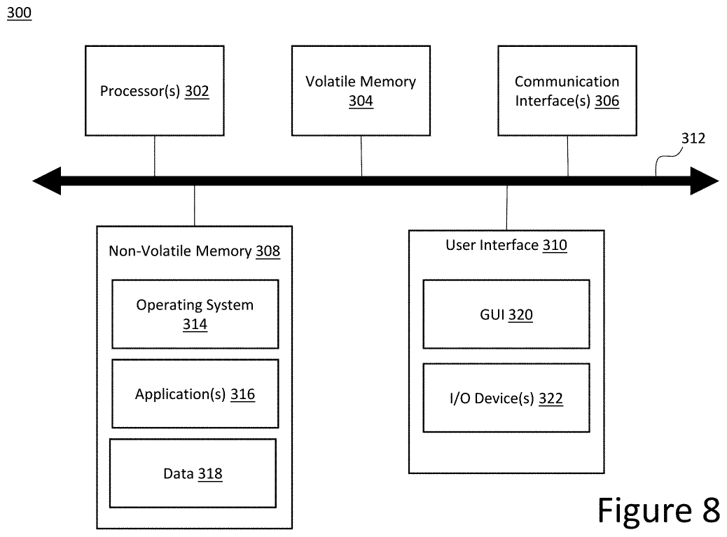

FIG. 8 depicts a block diagram of a computing device 100 useful for practicing an embodiment of client devices 102, appliances 108 and/or servers 106. The computing device 100 includes one or more processors 103, volatile memory 122 (e.g., random access memory (RAM)), non-volatile memory 128, user interface (UI) 123, one or more communications interfaces 118, and a communications bus 150.

The non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

The non-volatile memory 128 stores an operating system 115, one or more applications 116, and data 117 such that, for example, computer instructions of the operating system 115 and/or the applications 116 are executed by processor(s) 103 out of the volatile memory 122. In some embodiments, the volatile memory 122 may include one or more types of RAM and/or a cache memory that may offer a faster response time than a main memory. Data may be entered using an input device of the GUI 124 or received from the I/O device(s) 126. Various elements of the computer 100 may communicate via the communications bus 150.

The illustrated computing device 100 is shown merely as an example client device or server, and may be implemented by any computing or processing environment with any type of machine or set of machines that may have suitable hardware and/or software capable of operating as described herein.

The processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

The processor 103 may be analog, digital or mixed-signal. In some embodiments, the processor 103 may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

The communications interfaces 118 may include one or more interfaces to enable the computing device 100 to access a computer network such as a Local Area Network (LAN), a Wide Area Network (WAN), a Personal Area Network (PAN), or the Internet through a variety of wired and/or wireless connections, including cellular connections.

In described embodiments, the computing device 100 may execute an application on behalf of a user of a client device. For example, the computing device 100 may execute one or more virtual machines managed by a hypervisor. Each virtual machine may provide an execution session within which applications execute on behalf of a user or a client device, such as a hosted desktop session. The computing device 100 may also execute a terminal services session to provide a hosted desktop environment. The computing device 100 may provide access to a remote computing environment including one or more applications, one or more desktop applications, and one or more desktop sessions in which one or more applications may execute.

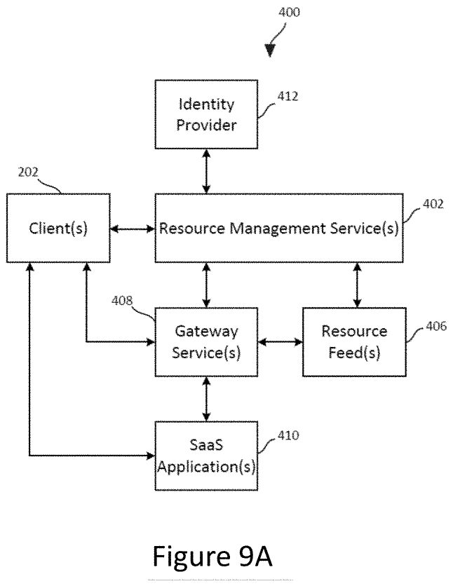

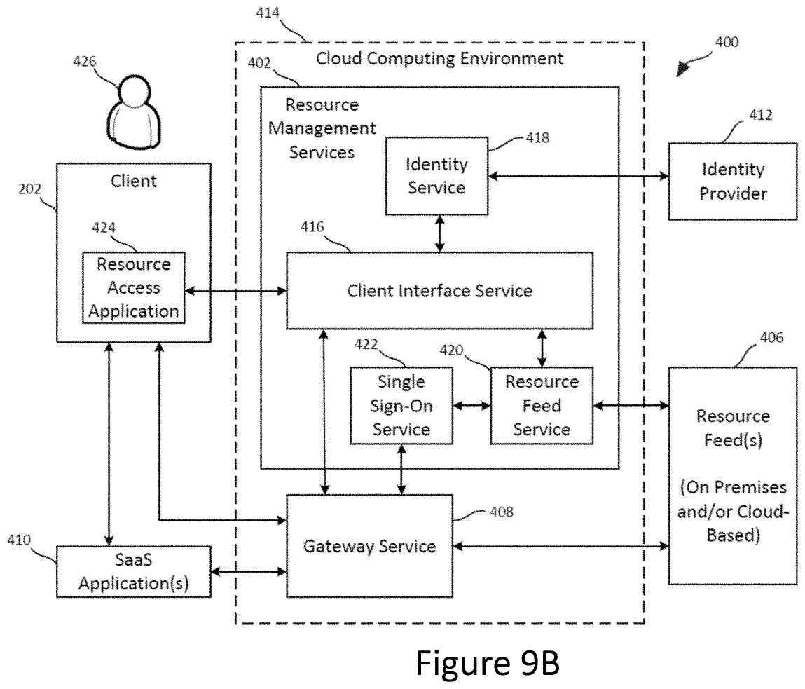

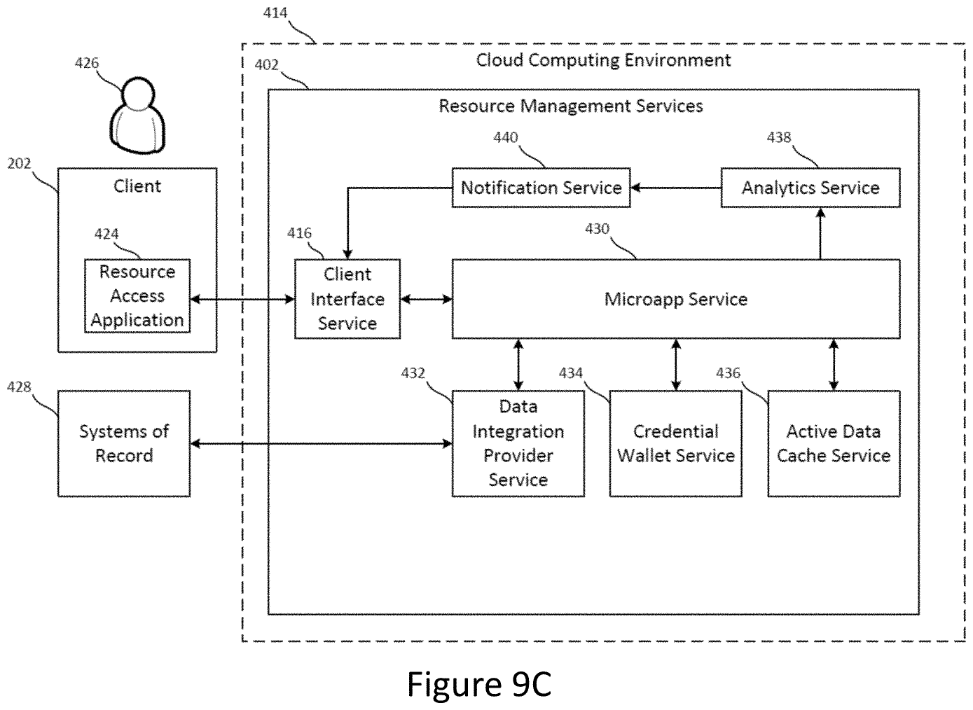

FIG. 9A is a block diagram of an example system 400 in which one or more resource management services 402 may manage and streamline access by one or more clients 202 to one or more resource feeds 406 (via one or more gateway services 408) and/or one or more software-as-a-service (SaaS) applications 410. In particular, the resource management service(s) 402 may employ an identity provider 412 to authenticate the identity of a user of a client 202 and, following authentication, identify one of more resources the user is authorized to access. In response to the user selecting one of the identified resources, the resource management service(s) 402 may send appropriate access credentials to the requesting client 202, and the client 202 may then use those credentials to access the selected resource. For the resource feed(s) 406, the client 202 may use the supplied credentials to access the selected resource via a gateway service 408. For the SaaS application(s) 410, the client 202 may use the credentials to access the selected application directly.

The client(s) 202 may be any type of computing devices capable of accessing the resource feed(s) 406 and/or the SaaS application(s) 410, and may, for example, include a variety of desktop or laptop computers, smartphones, tablets, etc. The resource feed(s) 406 may include any of numerous resource types and may be provided from any of numerous locations. In some embodiments, for example, the resource feed(s) 406 may include one or more systems or services for providing virtual applications and/or desktops to the client(s) 202, one or more file repositories and/or file sharing systems, one or more secure browser services, one or more access control services for the SaaS applications 410, one or more management services for local applications on the client(s) 202, one or more internet enabled devices or sensors, etc. Each of the resource management service(s) 402, the resource feed(s) 406, the gateway service(s) 408, the SaaS application(s) 410, and the identity provider 412 may be located within an on-premises data center of an organization for which the system 400 is deployed, within one or more cloud computing environments, or elsewhere.

FIG. 9B is a block diagram showing an example implementation of the system 400 shown in FIG. 9A in which various resource management services 402 as well as a gateway service 408 are located within a cloud computing environment 414. The cloud computing environment may, for example, include Microsoft Azure Cloud, Amazon Web Services, Google Cloud, or IBM Cloud.

For any of illustrated components (other than the client 202) that are not based within the cloud computing environment 414, cloud connectors (not shown in FIG. 9B) may be used to interface those components with the cloud computing environment 414. Such cloud connectors may, for example, run on Windows Server instances hosted in resource locations and may create a reverse proxy to route traffic between the site(s) and the cloud computing environment 414. In the illustrated example, the cloud-based resource management services 402 include a client interface service 416, an identity service 418, a resource feed service 420, and a single sign-on service 422. As shown, in some embodiments, the client 202 may use a resource access application 424 to communicate with the client interface service 416 as well as to present a user interface on the client 202 that a user 426 can operate to access the resource feed(s) 406 and/or the SaaS application(s) 410. The resource access application 424 may either be installed on the client 202, or may be executed by the client interface service 416 (or elsewhere in the system 400) and accessed using a web browser (not shown in FIG. 9B) on the client 202.

As explained in more detail below, in some embodiments, the resource access application 424 and associated components may provide the user 426 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 424 is launched or otherwise accessed by the user 426, the client interface service 416 may send a sign-on request to the identity service 418. In some embodiments, the identity provider 412 may be located on the premises of the organization for which the system 400 is deployed. The identity provider 412 may, for example, correspond to an on-premises Windows Active Directory. In such embodiments, the identity provider 412 may be connected to the cloud-based identity service 418 using a cloud connector (not shown in FIG. 9B), as described above. Upon receiving a sign-on request, the identity service 418 may cause the resource access application 424 (via the client interface service 416) to prompt the user 426 for the user's authentication credentials (e.g., user-name and password). Upon receiving the user's authentication credentials, the client interface service 416 may pass the credentials along to the identity service 418, and the identity service 418 may, in turn, forward them to the identity provider 412 for authentication, for example, by comparing them against an Active Directory domain. Once the identity service 418 receives confirmation from the identity provider 412 that the user's identity has been properly authenticated, the client interface service 416 may send a request to the resource feed service 420 for a list of subscribed resources for the user 426.

In other embodiments (not illustrated in FIG. 9B), the identity provider 412 may be a cloud-based identity service, such as a Microsoft Azure Active Directory. In such embodiments, upon receiving a sign-on request from the client interface service 416, the identity service 418 may, via the client interface service 416, cause the client 202 to be redirected to the cloud-based identity service to complete an authentication process. The cloud-based identity service may then cause the client 202 to prompt the user 426 to enter the user's authentication credentials. Upon determining the user's identity has been properly authenticated, the cloud-based identity service may send a message to the resource access application 424 indicating the authentication attempt was successful, and the resource access application 424 may then inform the client interface service 416 of the successfully authentication. Once the identity service 418 receives confirmation from the client interface service 416 that the user's identity has been properly authenticated, the client interface service 416 may send a request to the resource feed service 420 for a list of subscribed resources for the user 426.

For each configured resource feed, the resource feed service 420 may request an identity token from the single sign-on service 422. The resource feed service 420 may then pass the feed-specific identity tokens it receives to the points of authentication for the respective resource feeds 406. Each resource feed 406 may then respond with a list of resources configured for the respective identity. The resource feed service 420 may then aggregate all items from the different feeds and forward them to the client interface service 416, which may cause the resource access application 424 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 202, and/or one or more SaaS applications 410 to which the user 426 has subscribed. The lists of local applications and the SaaS applications 410 may, for example, be supplied by resource feeds 406 for respective services that manage which such applications are to be made available to the user 426 via the resource access application 424. Examples of SaaS applications 410 that may be managed and accessed as described herein include Microsoft Office 365 applications, SAP SaaS applications, Workday applications, etc.

For resources other than local applications and the SaaS application(s) 410, upon the user 426 selecting one of the listed available resources, the resource access application 424 may cause the client interface service 416 to forward a request for the specified resource to the resource feed service 420. In response to receiving such a request, the resource feed service 420 may request an identity token for the corresponding feed from the single sign-on service 422. The resource feed service 420 may then pass the identity token received from the single sign-on service 422 to the client interface service 416 where a launch ticket for the resource may be generated and sent to the resource access application 424. Upon receiving the launch ticket, the resource access application 424 may initiate a secure session to the gateway service 408 and present the launch ticket. When the gateway service 408 is presented with the launch ticket, it may initiate a secure session to the appropriate resource feed and present the identity token to that feed to seamlessly authenticate the user 426. Once the session initializes, the client 202 may proceed to access the selected resource.

When the user 426 selects a local application, the resource access application 424 may cause the selected local application to launch on the client 202. When the user 426 selects a SaaS application 410, the resource access application 424 may cause the client interface service 416 request a one-time uniform resource locator (URL) from the gateway service 408 as well a preferred browser for use in accessing the SaaS application 410. After the gateway service 408 returns the one-time URL and identifies the preferred browser, the client interface service 416 may pass that information along to the resource access application 424. The client 202 may then launch the identified browser and initiate a connection to the gateway service 408. The gateway service 408 may then request an assertion from the single sign-on service 422. Upon receiving the assertion, the gateway service 408 may cause the identified browser on the client 202 to be redirected to the logon page for identified SaaS application 410 and present the assertion. The SaaS may then contact the gateway service 408 to validate the assertion and authenticate the user 426. Once the user has been authenticated, communication may occur directly between the identified browser and the selected SaaS application 410, thus allowing the user 426 to use the client 202 to access the selected SaaS application 410.

In some embodiments, the preferred browser identified by the gateway service 408 may be a specialized browser embedded in the resource access application 424 (when the resource application is installed on the client 202) or provided by one of the resource feeds 406 (when the resource application 424 is located remotely), e.g., via a secure browser service. In such embodiments, the SaaS applications 410 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 406) for assessment of its security risk by a web filtering service. For approved URLs, the specialized browser may be permitted to access the link. For suspicious links, however, the web filtering service may have the client interface service 416 send the link to a secure browser service, which may start a new virtual browser session with the client 202, and thus allow the user to access the potentially harmful linked content in a safe environment.

In some embodiments, in addition to or in lieu of providing the user 426 with a list of resources that are available to be accessed individually, as described above, the user 426 may instead be permitted to choose to access a streamlined feed of event notifications and/or available actions that may be taken with respect to events that are automatically detected with respect to one or more of the resources. This streamlined resource activity feed, which may be customized for each user 426, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 426 of something that requires the user's attention (e.g., approval of an expense report, new course available for registration, etc.).

FIG. 9C is a block diagram similar to that shown in FIG. 9B but in which the available resources (e.g., SaaS applications, web applications, Windows applications, Linux applications, desktops, file repositories and/or file sharing systems, and other data) are represented by a single box 428 labeled “systems of record,” and further in which several different services are included within the resource management services block 402. As explained below, the services shown in FIG. 9C may enable the provision of a streamlined resource activity feed and/or notification process for a client 202. In the example shown, in addition to the client interface service 416 discussed above, the illustrated services include a microapp service (or simply “microservice”) 430, a data integration provider service 432, a credential wallet service 434, an active data cache service 436, an analytics service 438, and a notification service 440. In various embodiments, the services shown in FIG. 9C may be employed either in addition to or instead of the different services shown in FIG. 9B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 424 without having to launch the native application. The system shown in FIG. 9C may, for example, aggregate relevant notifications, tasks, and insights, and thereby give the user 426 a dynamic productivity tool. In some embodiments, the resource activity feed may be intelligently populated by utilizing machine learning and artificial intelligence (AI) algorithms. Further, in some implementations, microapps may be configured within the cloud computing environment 414, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 9C, the systems of record 428 may represent the applications and/or other resources the resource management services 402 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 402, and in particular the data integration provider service 432, may, for example, support REST API, JSON, OData-JSON, and 6ML. As explained in more detail below, the data integration provider service 432 may also write back to the systems of record, for example, using OAuth2 or a service account.

In some embodiments, the microapp service 430 may be a single-tenant service responsible for creating the microapps. The microapp service 430 may send raw events, pulled from the systems of record 428, to the analytics service 438 for processing. The microapp service may, for example, periodically pull active data from the systems of record 428.

In some embodiments, the active data cache service 436 may be single-tenant and may store all configuration information and microapp data. It may, for example, utilize a per-tenant database encryption key and per-tenant database credentials.

In some embodiments, the credential wallet service 434 may store encrypted service credentials for the systems of record 428 and user OAuth2 tokens.

In some embodiments, the data integration provider service 432 may interact with the systems of record 428 to decrypt end-user credentials and write back actions to the systems of record 428 under the identity of the end-user. The write-back actions may, for example, utilize a user's actual account to ensure all actions performed are compliant with data policies of the application or other resource being interacted with.

In some embodiments, the analytics service 438 may process the raw events received from the microapps service 430 to create targeted scored notifications and send such notifications to the notification service 440.

Finally, in some embodiments, the notification service 440 may process any notifications it receives from the analytics service 438. In some implementations, the notification service 440 may store the notifications in a database to be later served in a notification feed. In other embodiments, the notification service 440 may additionally or alternatively send the notifications out immediately to the client 202 as a push notification to the user 426.

In some embodiments, a process for synchronizing with the systems of record 428 and generating notifications may operate as follows. The microapp service 430 may retrieve encrypted service account credentials for the systems of record 428 from the credential wallet service 434 and request a sync with the data integration provider service 432. The data integration provider service 432 may then decrypt the service account credentials and use those credentials to retrieve data from the systems of record 428. The data integration provider service 432 may then stream the retrieved data to the microapp service 430. The microapp service 430 may store the received systems of record data in the active data cache service 436 and also send raw events to the analytics service 438. The analytics service 438 may create targeted scored notifications and send such notifications to the notification service 440. The notification service 440 may store the notifications in a database to be later served in a notification feed and/or may send the notifications out immediately to the client 202 as a push notification to the user 426.

In some embodiments, a process for processing a user-initiated action via a microapp may operate as follows. The client 202 may receive data from the microapp service 430 (via the client interface service 416) to render information corresponding to the microapp. The microapp service 430 may receive data from the active data cache service 436 to support that rendering. The user 426 may invoke an action from the microapp, causing the resource access application 424 to send that action to the microapp service 430 (via the client interface service 416). The microapp service 430 may then retrieve from the credential wallet service 434 an encrypted Oauth2 token for the system of record for which the action is to be invoked, and may send the action to the data integration provider service 432 together with the encrypted Oath2 token. The data integration provider service 432 may then decrypt the Oath2 token and write the action to the appropriate system of record under the identity of the user 426. The data integration provider service 432 may then read back changed data from the written-to system of record and send that changed data to the microapp service 430. The microapp service 432 may then update the active data cache service 436 with the updated data and cause a message to be sent to the resource access application 424 (via the client interface service 416) notifying the user 426 that the action was successfully completed.

In some embodiments, in addition to or in lieu of the functionality described above, the resource management services 402 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 402 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 402 may, for example, parse these requests and respond because they are integrated with multiple systems on the back-end. In some embodiments, users may be able to interact with the virtual assistance through either the resource access application 424 or directly from another resource, such as Microsoft Teams. This feature may allow employees to work efficiently, stay organized, and deliver only the specific information they're looking for.

The following paragraphs (S1) through (S11) describe examples of systems and devices that may be implemented in accordance with the present disclosure.

(S1) A computing device may comprise a display; a memory storing instructions; and a processor coupled to the memory and the display and configured to execute the instructions to perform processes including: detecting a launch of an application on the computing device, the application being executable locally on the computing device; rendering an element in a user interface presented within the display, the element configured to substitute the application with a corresponding application that executes on a remote computing device; in response to input received on the element, launching the corresponding application on the remote computing device, the corresponding application being accessible on the computing device; and terminating execution of the application on the computing device.

(S2) A computing device may be configured as described in paragraph (S1), wherein the computing device comprises a client device configured to run a workspace client, and in response to detecting the launch of the application, forwarding application information from the workspace client to a workspace platform running on the remote computing device to determine whether the corresponding application exists within the workspace platform; and in response to determining that the corresponding application exists within the workspace platform, rendering the element with an option to switch from the application to the corresponding application.

(S3) A computing device may be configured as described in paragraph (S2), wherein launching the corresponding application includes: sending a request from the workspace client to the workspace platform for an application configuration file; and receiving and running the application configuration file at the workspace client.

(S4) A computing device may be configured as described in paragraphs (S1)-(S3), wherein the element includes a button rendered in the application.

(S5) A computing device may be configured as described in paragraph (S4), wherein the button is rendered on a menu bar of a window containing the application.

(S6) A computing device may be configured as described in paragraphs (S4)-(S5), wherein a location of the button on the menu bar is determined based on a width of the window and a distance between a right border of the window and an existing structure on the menu bar.

(S7) A computing device may be configured as described in paragraphs (S4)-(S6), wherein the button is movable by a user.

(S8) A computing device may be configured as described in paragraph (S1)-(S7), wherein a pop-up dialog of user selectable choices is displayed in response to a mouse cursor being hovered over the element, the user selectable choices including an option to open the corresponding application in a secure browser.

(S9) A computing device may be configured as described in paragraph (S2), wherein the application information includes at least one of an application name, an executable name, a manufacturer name, or a signing key.

(S10) A computing device may be configured as described in paragraph (S9), wherein the application name is compared with resource names available in the workspace platform to determine if the corresponding application exists.

(S11) A computing device may be configured as described in paragraph (S1), wherein launching the corresponding application on the remote computing device includes one of: initiating a session on the remote computing device, utilizing a secure browser service, or utilizing a secure browser.

The following paragraphs (M1) through (M11) describe examples of methods that may be implemented in accordance with the present disclosure.

(M1) A method may involve switching to remote applications on a computing device, comprising: detecting a launch of an application on the computing device, the application being executable locally on the computing device; rendering an element in a user interface presented within a display of the computing device, the element configured to substitute the application with a corresponding application that executes on a remote computing device; in response to input received on the element, launching the corresponding application on the remote computing device and terminating execution of the application on the computing device.

(M2) A method may be provided as described in paragraph (M1), wherein the computing device is configured to run a workspace client, and in response to detecting the launch of the application, forwarding application information from the workspace client to a workspace platform running on the remote computing device to determine whether the corresponding application exists within the workspace platform; and in response to determining that the corresponding application exists within the workspace platform, rendering the element with an option to switch from the application to the corresponding application.

(M3) A method may be provided as described in paragraph (M2), wherein launching the corresponding application includes: sending a request from the workspace client to the workspace platform for an application configuration file; and receiving and running the application configuration file at the workspace client.

(M4) A method may be provided as described in paragraphs (M1)-(M3), wherein the element includes a button rendered in the application.

(M5) A method may be provided as described in paragraph (M4), wherein the button is rendered on a menu bar of a window containing the application.

(M6) A method may be provided as described in paragraph (M4)-(M5), wherein a location of the button on the menu bar is determined based on a width of the window and a distance between a right border of the window and an existing structure on the menu bar.

(M7) A method may be provided as described in paragraph (M4)-(M6), wherein the button is movable by a user.

(M8) A method may be provided as described in paragraphs (M1)-(M7), wherein a pop-up dialog of user selectable choices is displayed in response to a mouse cursor being hovered over the element, the user selectable choices including an option to open the corresponding application in a secure browser.

(M9) A method may be provided as described in paragraph (M2), wherein the application information includes at least one of an application name, an executable name, a manufacturer name, or a signing key.

(M10) A method may be provided as described in paragraph (M9), wherein the application name is compared with resource names available in the virtual workspace platform to determine if the corresponding application exists.

(M11) A method may be provided as described in paragraph (M1), wherein launching the corresponding application on the remote computing device includes one of: initiating a session on the remote computing device, utilizing a secure browser service or utilizing a secure browser.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

We claim:

1. A computing device, comprising:
a display;
a memory storing instructions; and
a processor coupled to the memory and the display and configured to execute the instructions to perform processes including:
detecting a launch of an application on the computing device, the application being executable locally on the computing device;
rendering an element within the display, the element configured to substitute the application with a corresponding application that executes on a remote computing device;
in response to input received on the element, launching the corresponding application on the remote computing device, the corresponding application being accessible locally on the computing device; and
terminating execution of the application on the computing device.

2. The computing device of claim 1, wherein the computing device comprises a client device configured to run a workspace client, and
in response to detecting the launch of the application, forwarding application information from the workspace client to a workspace platform running on the remote computing device to determine whether the corresponding application exists within the workspace platform; and
in response to determining that the corresponding application exists within the workspace platform, rendering the element configured with an option to switch from the application to the corresponding application.

3. The computing device of claim 2, wherein launching the corresponding application includes:
sending a request from the workspace client to the workspace platform for an application configuration file; and
receiving and running the application configuration file at the workspace client.

4. The computing device of claim 1, wherein the element includes a button rendered in the application.

5. The computing device of claim 4, wherein the button is rendered on a menu bar of a window containing the application.

6. The computing device of claim 5, wherein a location of the button on the menu bar is determined based on a width of the window and a distance between a right border of the window and an existing structure on the menu bar.

7. The computing device of claim 1, wherein launching the corresponding application on the remote computing device includes one of: initiating a session on the remote computing device, utilizing a secure browser service or utilizing a secure browser.

8. The computing device of claim 1, wherein a pop-up dialog of user selectable choices is displayed in response to a mouse cursor being hovered over the element, the user selectable choices including an option to open the corresponding application in a secure browser.

9. The computing device of claim 2, wherein the application information includes at least one of an application name, an executable name, a manufacturer name, or a signing key.

10. The computing device of claim 9, wherein the application name is compared with resource names available in the workspace platform to determine if the corresponding application exists.

11. A method comprising:
detecting a launch of an application on the computing device, the application being executable locally on the computing device;
rendering an element in a user interface presented within a display of the computing device, the element configured to substitute the application with a corresponding application that executes on a remote computing device; and
in response to input received on the element, launching the corresponding application on the remote computing device and terminating execution of the application on the computing device.

12. The method of claim 11, wherein the computing device is configured to run a workspace client, and
in response to detecting the launch of the application, forwarding application information from the workspace client to a workspace platform running on the remote computing device to determine whether the corresponding application exists within the workspace platform; and
in response to determining that the corresponding application exists within the workspace platform, rendering the element with an option to switch from the application to the corresponding application.

13. The method of claim 12, wherein launching the corresponding application includes:
sending a request from the workspace client to the workspace platform for an application configuration file; and
receiving and running the application configuration file at the workspace client.

14. The method of claim 11, wherein the element includes a button rendered in the application.

15. The method of claim 14, wherein the button is rendered on a menu bar of a window containing the application.

16. The method of claim 15, wherein a location of the button on the menu bar is determined based on a width of the window and a distance between a right border of the window and an existing structure on the menu bar.

17. The method of claim 11, wherein launching the corresponding application on the remote computing device includes one of: initiating a session on the remote computing device, utilizing a secure browser service or a secure browser.

18. The method of claim 11, wherein a pop-up dialog of user selectable choices is displayed in response to a mouse cursor being hovered over the element, the user selectable choices including an option to open the corresponding application in a secure browser.

19. The method of claim 12, wherein the application information includes at least one of an application name, an executable name, a manufacturer name, or a signing key.

20. The method of claim 19, wherein the application name is compared with resource names available in the virtual workspace platform to determine if the corresponding application exists.
